(19) United States
(12) Patent Application Publication
(10) Pub. No.: US 2009/0199536 A1
(43) Pub. Date: Aug. 13, 2009

(54) PROCESS FOR REVERSING THE THRUST PRODUCED BY A PROPULSION UNIT OF AN AIRCRAFT, DEVICE FOR ITS IMPLEMENTATION, NACELLE EQUIPPED WITH SAID DEVICE

(75) Inventors: Guillaume Bulin, Blagnac (FR); Patrick Oberle, Verdun Sur Garonne (FR); Thierry Surply, Cornebarrieu (FR)

Correspondence Address: YOUNG & THOMPSON, 209 Madison Street, Suite 500, ALEXANDRIA, VA, 22314, US

(73) Assignee: AIRBUS FRANCE, Toulouse (FR)

(21) Appl. No.: 12/307,483

(22) PCT Filed: Jun. 28, 2007
(86) PCT No.: PCT/FR2007/051553

§ 371 Date: Jan. 5, 2009

(30) Foreign Application Priority Data
Jul. 5, 2006 (FR) 0606113
Jan. 5, 2007 (FR) 0752545

(51) Int. Cl. F02K 3/02

(52) U.S. Cl. 60/226.2

(57) ABSTRACT

The object of the invention is a process whose purpose is to reduce, cancel or reverse the thrust generated by at least one air flow exiting from a propulsion unit of an aircraft by deflecting at least a portion of the flow that is able to assist the thrust, characterized in that it consists in injecting at the level of the propulsion unit a fluid called a thrust reversal fluid to deflect by an entrainment effect, from the inside of the nacelle toward the outside of the nacelle, at least a portion of the flow that is able to assist the thrust.

This invention relates to a process for reducing, canceling or reversing the thrust produced by a propulsion unit of an aircraft, to a device for its implementation, as well as to an aircraft nacelle that incorporates said device.

A propulsion unit comprises a nacelle in the form of a conduit in which a power plant, in particular a gas turbine engine, is arranged in an essentially concentric manner, driving a fan mounted on its shaft.

At the front, the nacelle comprises an air intake, whereby a first portion of the entering air flow, called primary flow, passes through the power plant to assist the combustion; the second portion of the air flow, called secondary flow, is swept along by the fan and flows into an annular conduit that is delimited by the inside wall of the nacelle and the outside wall of the power plant.

Thus, the thrust that is generated by the propulsion unit, oriented essentially along the longitudinal axis of the nacelle, is produced by the primary air flow ejected by the power plant and the secondary air flow driven by the fan.

On the nacelles of a propulsion unit of an aircraft, it is known to provide mechanical systems to reverse the thrust that is produced so as to achieve a deceleration of the aircraft.

This system makes it possible to compensate for the action of the brakes when the adhesion to the ground is reduced, for example, in the presence of black ice, to stress the braking devices less, which makes it possible to reduce the maintenance of said braking devices, and to reduce the deceleration period, which makes it possible to reduce the time the runway is occupied.

The document GB-1,357,370 describes such a mechanical system for reversing the thrust produced by an aircraft propulsion unit. According to this document, the nacelle is formed by a front part and a rear part that can move in translation so as to provide an opening between the two parts.

Deflectors such as, for example, flaps or doors are deployed in the annular conduit downstream from the opening so as to block the secondary flow and deflect it toward the opening. Thus, said secondary flow is evacuated radially outside of the nacelle via the opening and no longer assists the thrust, which is reflected by a deceleration.

According to other variants, one or more deflectors can be provided for deflecting the secondary flow and/or the primary flow.

In addition, means for orienting the flow of deflected air can be provided on the outside of the nacelle. These means make it possible to orient the resultant, along the longitudinal axis of the nacelle, generated by the deflected flow that can oppose the thrust and produce a more or less significant deceleration.

According to a first embodiment, it is possible to achieve this effect by tilting the deflectors to a greater or lesser extent.

According to an embodiment that is illustrated by the document GB-1,357,370, the Coanda effect is used.

Thus, the pressurized air can be injected via orifices that are located on the outside surface of the nacelle to the front of the opening to orient the deflected air flow toward the front or toward the rear of the opening to orient the flow toward the rear. Advantageously, the pressurized air can be drawn off at the compressor of the gas turbine engine and directed via conduits to orifices located at the outside surface of the nacelle.

According to this document, the Coanda effect is used only for orienting the deflected flow but does not assist the deflection of the air flow that is achieved by mechanical obstacles.

This type of reverser that uses at least one mechanical obstacle is not completely satisfactory for the following reasons:

The deflectors that are used to deflect the air flow as well as the elements for maneuvering them are sized to support the stresses that are likely to be generated during an ill-timed opening with a maximum thrust, which leads to increasing the on-board weight and to having a detrimental effect on the aircraft in terms of energy consumption.

The deflectors and the maneuvering elements are relatively complex, which leads to increasing the maintenance and the duration of down time on the ground.

These deflector/maneuvering element moving parts are generally incompatible with acoustic coatings, so that the surface areas treated in an acoustic manner are small.

Finally, these deflectors should not be deployed during the flight in an ill-timed manner, so that it is necessary to provide one or more safety systems that increase the on-board weight and the maintenance, having a detrimental effect on the aircraft as far as energy consumption and time of use are concerned.

Also, this invention aims at eliminating the drawbacks of the prior art by proposing a process that makes it possible to reduce, cancel, or reverse the thrust that is generated by a propulsion unit of an aircraft of simple design, making it possible to reduce the on-board weight and the maintenance so as to reduce the energy consumption and the duration of the aircraft's down time on the ground.

For this purpose, the invention has as its object a process that aims to reduce, cancel or reverse the thrust that is generated by at least one air flow exiting from a propulsion unit of an aircraft by deflecting at least a portion of the flow that is able to assist the thrust, characterized in that it consists in injecting at the level of the propulsion unit a fluid called a thrust reversal fluid to deflect by entrainment, from the inside of the nacelle toward the outside of the nacelle, at least a portion of the flow that is able to assist the thrust.

Thus, contrary to the prior art, a fluid-type thrust reversal system that is not based on at least one obstacle that can be arranged in a conduit so as to deflect a portion of the flow is obtained.

Other characteristics and advantages will emerge from the following description of the invention, a description that is provided only by way of example, taking into account the accompanying drawings in which:

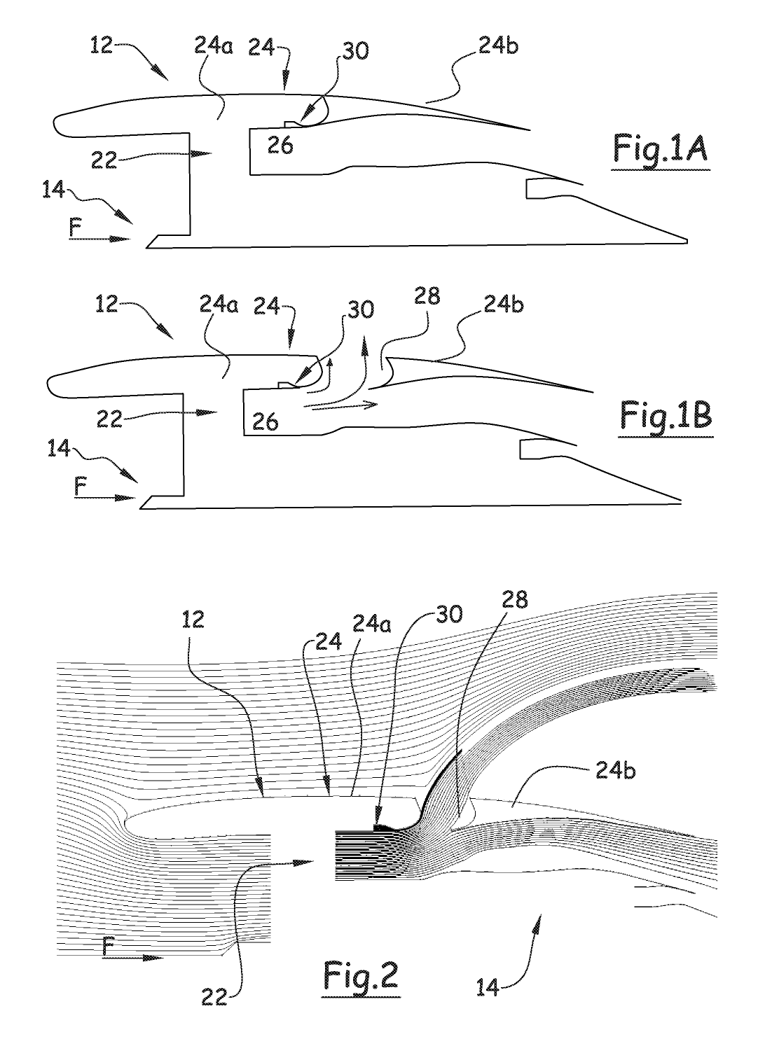

FIG. 1A is a diagrammatic representation in accordance with a longitudinal half-section of a propulsion unit of an aircraft according to the invention, whereby the thrust reversal is inactive,

FIG. 1B is a diagrammatic representation in accordance with a longitudinal half-section of a propulsion unit of an aircraft according to the invention, whereby the thrust reversal is active,

FIG. 2 is a representation that illustrates the different flows during the reduction, the cancellation or the reversal of thrust, in this case a reduction in thrust in the example shown,

FIG. 3 is a longitudinal cutaway of a propulsion unit of an aircraft according to the invention, in a rest state in the upper part, in an active state in the lower part,

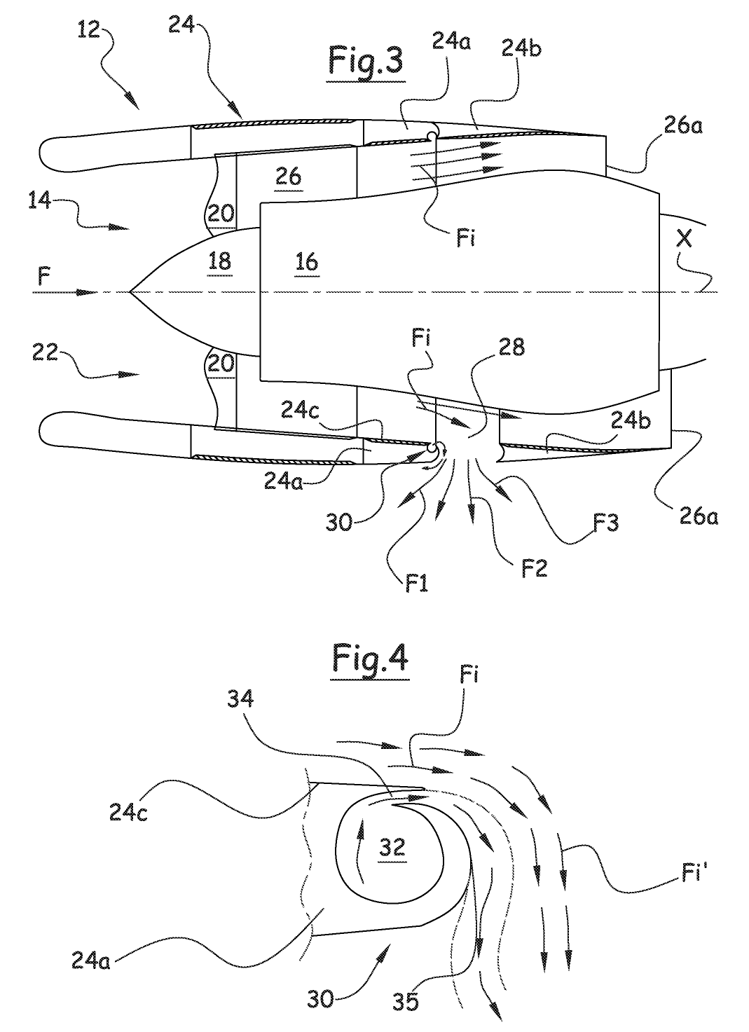

FIG. 4 is a diagrammatic view that illustrates in detail a fluid device according to one embodiment,

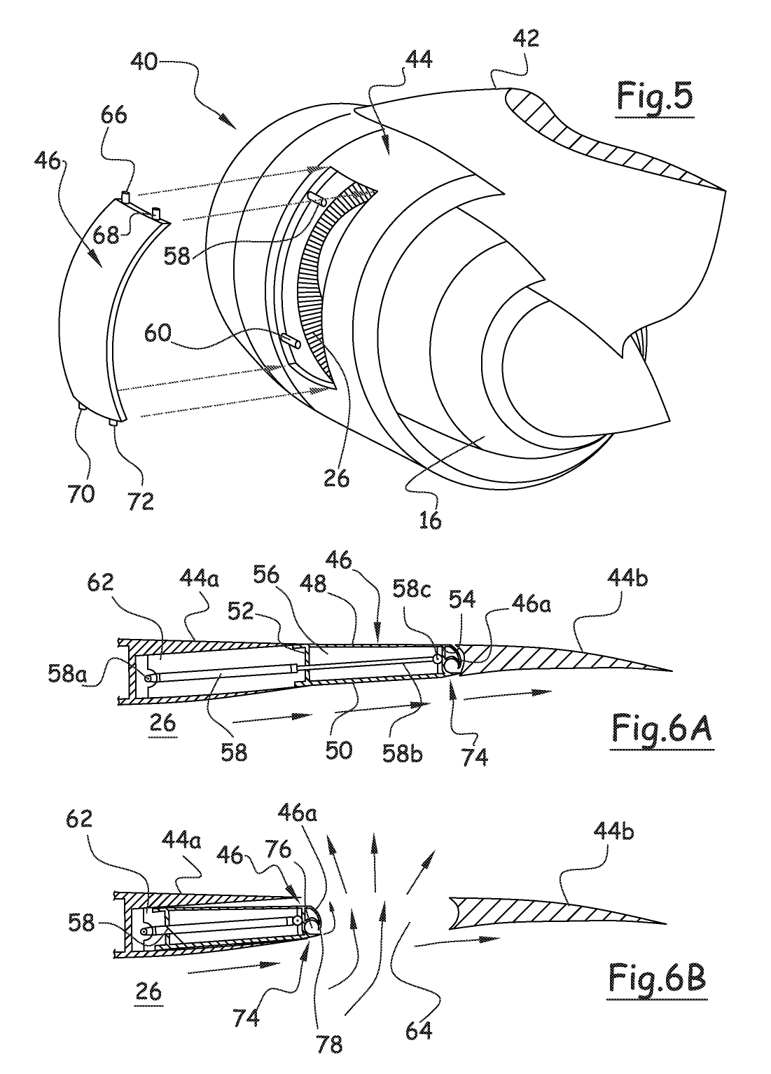

FIG. 5 is a perspective of a nacelle of an aircraft according to a second embodiment,

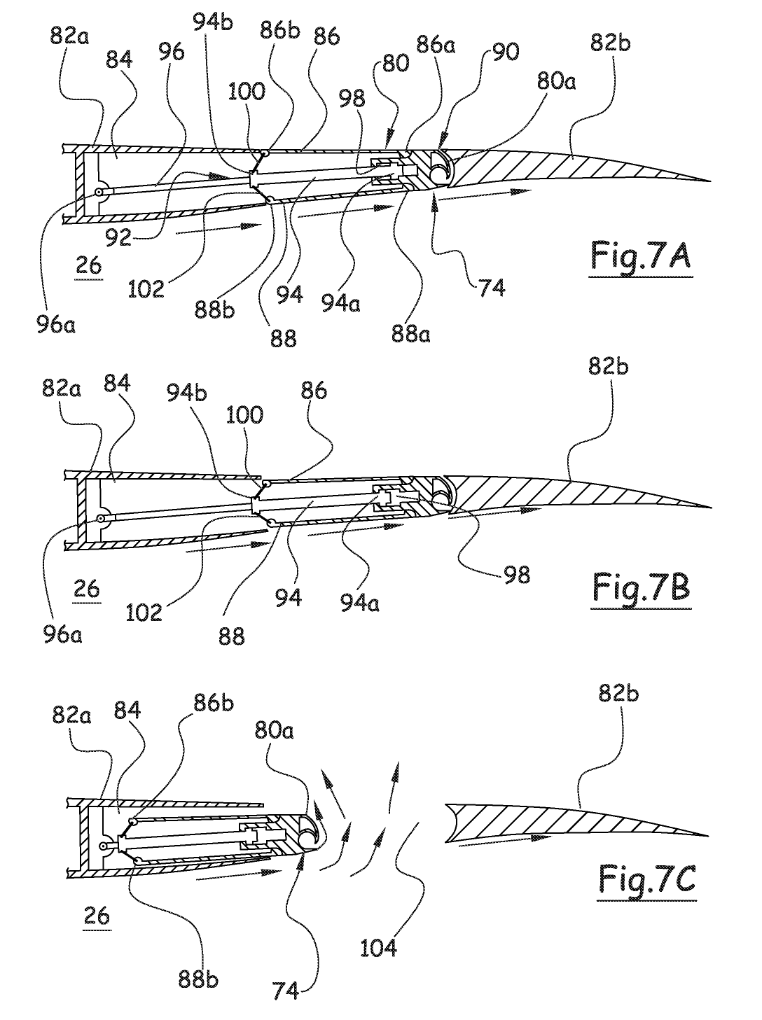

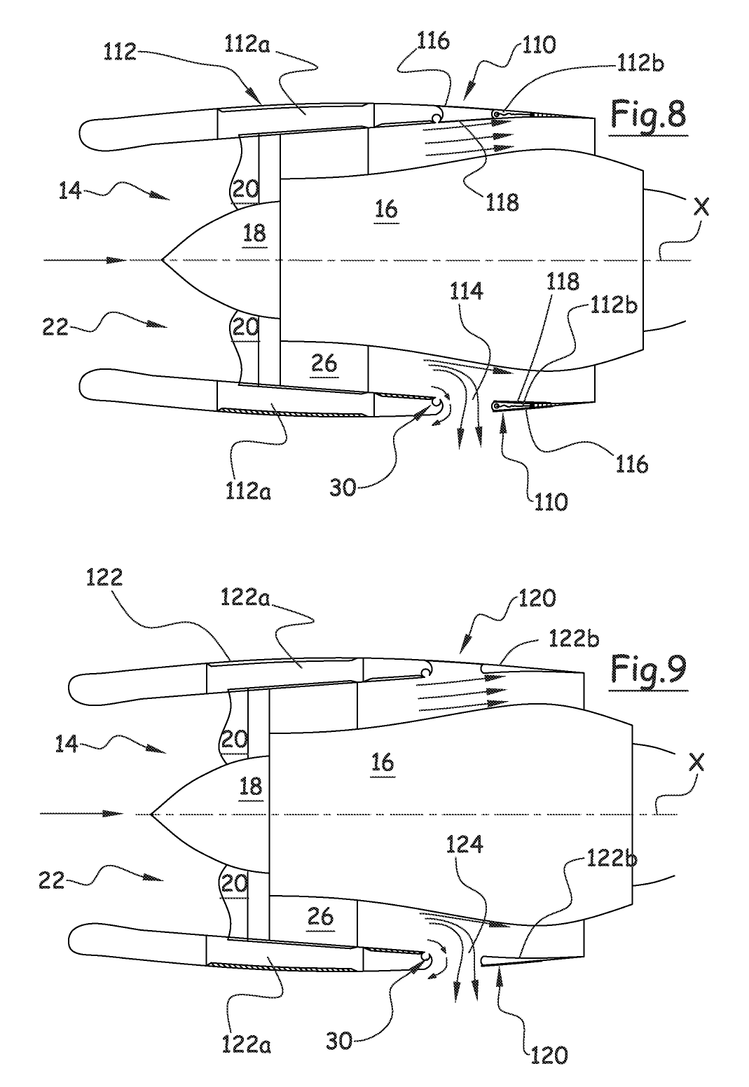

FIGS. 6A and 6B are cutaways that illustrate in detail the device of the invention according to the variant of FIG. 5, respectively in the rest state and in the active state,

FIGS. 7A to 7C are cutaways that illustrate in detail a device for reversing the thrust according to another variant of the invention, respectively in the rest state, in an intermediate position, and in the active state,

FIG. 8 is a longitudinal cutaway of a propulsion unit of an aircraft according to another variant of the invention, in the rest state in the upper part, in the active state in the lower part,

FIG. 9 is a longitudinal cutaway of a propulsion unit of an aircraft according to another variant of the invention, in the rest state in the upper part, in the active state in the lower part,

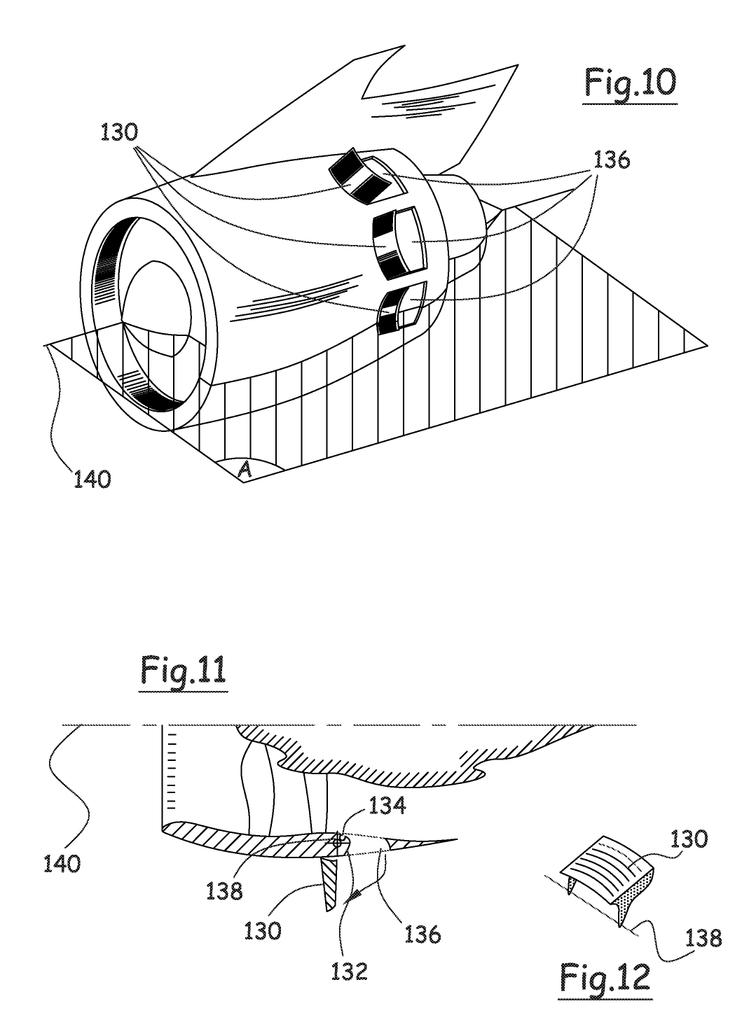

FIG. 10 is a perspective view of a propulsion unit that illustrates another variant of the invention,

FIG. 11 is a cutaway view along plane A of FIG. 10 of a portion of a nacelle that illustrates in detail the variant of the invention that is shown in FIG. 10,

FIG. 12 is a perspective view of a flap that is used for the variant of FIG. 10,

FIG. 13 is a longitudinal view of a propulsion unit of an aircraft according to another variant of the invention, in the rest state in the upper part, in the active state in the lower part, and

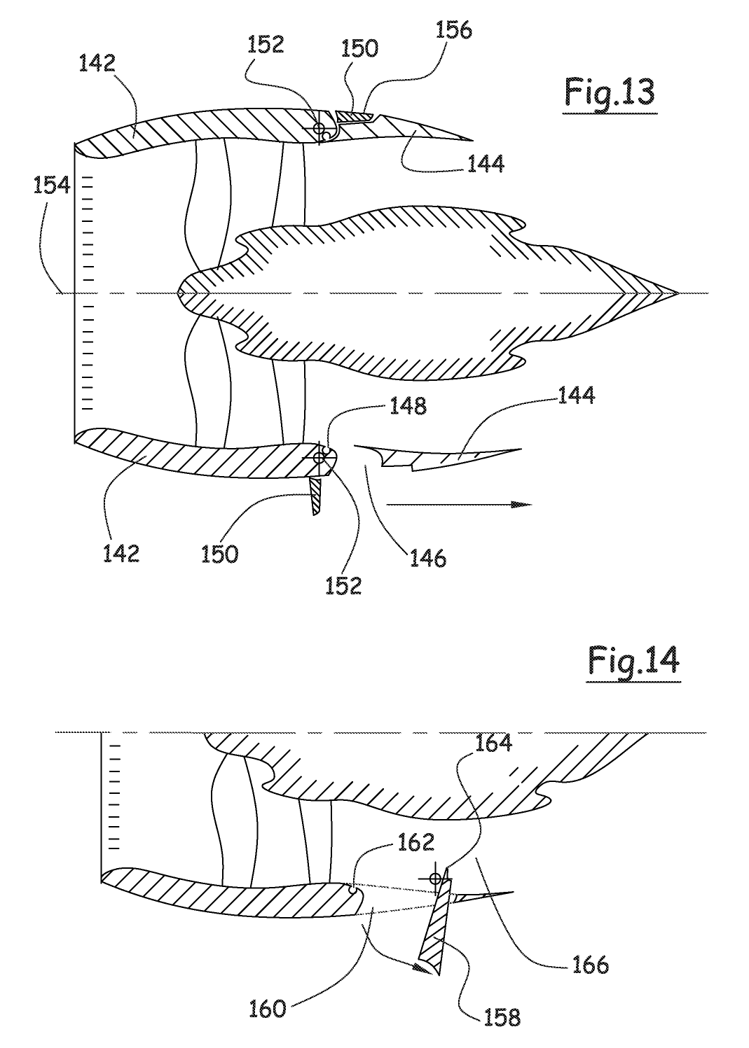

FIG. 14 is a longitudinal cutaway of a propulsion unit of an aircraft according to another variant of the invention, in the active state.

A propulsion unit for an aircraft comprises a nacelle 12 in which a power plant such as a jet engine 14 is arranged in an essentially concentric manner.

Thus, an aircraft can comprise one or more propulsion units attached to the wing or directly to the fuselage, either on both sides of the fuselage, or on the upper rear portion of the fuselage.

A jet engine 14, with a longitudinal axis X, installed inside the nacelle, comprises a gas turbine engine 16 that comprises at the inlet, on the upstream side (to the left in the figure), a shaft 18 on which are mounted the blades 20 of a fan 22. The nacelle 12 surrounds the above-mentioned jet engine 14 in its upstream part, while its downstream part projects relative to the downstream part of the nacelle as shown partially in FIG. 1.

More particularly, the nacelle 12 comprises a wall 24 that concentrically surrounds the jet engine so as to locate with the latter an annular conduit 26 into which flows a fluid which, here, is air.

The air, symbolized by the arrow F, arriving at the entrance of the nacelle, penetrates inside the latter, and a first flow, called primary flow, penetrates into the gas turbine engine 16 to assist the combustion and drive the shaft 18 and therefore the fan 22 in rotation.

In this way, a second air flow, called secondary flow, driven by the fan, makes use of the annular conduit 26 and escapes by the downstream part of the nacelle, thus constituting with the primary flow the thrust of the propulsion system.

According to one embodiment, the wall 24 of the nacelle is made of two parts, one so-called upstream part 24a and one so-called downstream part 24b that includes the trailing edge of the wall of the nacelle and that is moving relative to the first part.

As shown in FIG. 3, the second part 24b is shown in the upper part of this figure, in a first so-called folded position and for which the internal flow to the annular conduit 26 passes through the latter up to its emergent end 26a.

In the bottom part of FIG. 3, the downstream or rear part 24b is shown in a second so-called deployed position for which an opening 28 is created in the wall 24. This opening is located between the upstream parts 24a and downstream parts 24b at the outside periphery of the annular conduit 26.

It should be noted that the downstream part 24b of the wall of the nacelle can consist of several portions whose combination forms a complete ring and that can each move independently.

The downstream movement of each portion thus creates a different opening in the wall of the nacelle.

In the embodiment that is shown in FIG. 3, the downstream part 24b of the wall of the nacelle moves on command (for example, from a signal sent from the control station), by movement in translation (for example, under the action of hydraulic struts mounted in the wall part 24a, parallel to axis X), from the folded position to the deployed position to create one or more annular or semi-annular openings in the wall.

It will be noted that this mechanism for creating openings does not obstruct the annular longitudinal pipe 26, and a portion of the internal flow of fluid circulating in this passage can continue to escape via the end 26a.

It will be noted that at their zones that are designed to come into contact with one another, the upstream part 24a and the downstream part 24b of the wall of the nacelle have complementary shapes, namely, for example, a convex shape for the part 24a and a concave shape for the part 24b so that the unit that consists of two parts is contiguous when they are in contact with one another (upper part of FIG. 3).

According to the invention, a fluid called a thrust reversal fluid is injected at the level of the propulsion unit to deflect at least a portion of the secondary flow on the outside of the nacelle, in a radial direction, so that said deflected flow does not assist the thrust that is produced by the propulsion unit so as to achieve a deceleration.

Contrary to the prior art, a fluid-type thrust reversal that is not based on at least one obstacle and that can be arranged in a conduit so as to deflect a portion of the flow is achieved.

According to the invention, the deflection of at least a portion of the flow that is used for the thrust is achieved by a driving effect of said portion of the flow by the thrust reversal fluid, in particular using a Coanda effect.

Thus, contrary to the prior art, the Coanda effect is used to initiate the deflection of a portion of the flow that is used for the thrust.

Preferably, a thrust reversal fluid is injected at the level of at least one portion of a trailing edge or slightly upstream from said trailing edge to achieve a Coanda effect and to draw in and deflect at least a portion of the flow that is used for the thrust.

By way of example, the different flows are shown in FIG. 2. According to the invention, it is possible to deflect roughly 60% of the secondary flow by a driving effect of the thrust reversal fluid. Thus, with a secondary flow that has a flow rate of roughly 800 Kg/s upstream from the thrust reverser and a thrust reversal fluid that has a flow rate of roughly 70 Kg/s, it is possible to measure a flow rate of roughly 550 Kg/s for the deflected flow.

The thrust reversal fluid can be injected selectively with one or more injection points that are distributed along the trailing edge or linearly over a portion or several portions of the trailing edge.

This trailing edge can be the trailing edge of the end of the conduit that channels the secondary flow and/or the conduit that channels the primary flow or that of an upstream edge of an orifice that is provided at the conduit that channels the secondary flow and/or the conduit that channels the primary flow.

Thus, this invention is not limited to the deflection of the secondary flow but may apply also to the primary flow.

Likewise, the deflection of a portion of the flow so that it no longer assists the thrust can be carried out via an orifice that can be created at a conduit or at the end of a conduit.

In addition, the injection of the thrust reversal fluid can be arranged along the trailing edge or in an offset manner upstream or downstream from said trailing edge.

Advantageously, the thrust reversal fluid is injected via a nozzle-type discharge. This fluid is preferably drawn off at the compressor of the jet engine.

Reversal of thrust is defined below as the reduction, the cancellation or the reversal of the thrust.

During the reduction in thrust, at least a portion of the fluid that is likely to assist the thrust is deflected in a direction that makes an acute angle with the thrust direction. In this case, the propulsion unit generates a thrust that is oriented toward the rear.

For the cancellation of the thrust, the resultant of the deflected flow is equal to the resultant of the non-deflected flow. In this case, the propulsion unit generates an almost-zero thrust.

For the reversal of thrust, the resultant of the deflected flow is greater than that of the non-deflected flow; in this case, the propulsion unit generates a thrust that is oriented toward the front.

Preferably, it is possible to adjust the ratio between the flow rate of the deflected flow and the flow rate of the non-deflected flow by adjusting at least one aerodynamic or thermodynamic parameter of the thrust reversal fluid, such as, for example, the rate of injection of the thrust reversal fluid.

To the extent that the means for deflecting a portion of the air flow are not a mechanical obstacle and do not comprise any means for maneuvering them, the thrust reversal system is greatly simplified.

Furthermore, this system makes it possible to greatly reduce the on-board weight and therefore the consumption of the aircraft.

Furthermore, even when parts of the nacelle slide in translation, the number of parts in movement is relatively low, which makes it possible to reduce the maintenance and the duration of the aircraft's down time on the ground.

Finally, this thrust reversal system makes it possible to enlarge the surface areas that are treated acoustically and to extend them up to the zones of the nacelle that are dedicated to the thrust reversal.

According to the variants, it is possible to use means for orienting the deflected flow either toward the front of the nacelle or toward the rear. For this purpose, it is possible to use, as for the prior art, conduits that emerge at the outside surface of the nacelle, upstream and downstream from the opening to orient the deflected flow. Thus, when air is injected via the orifice that is arranged upstream from the opening, the deflected air flow is oriented in an oblique direction toward the front of the nacelle, whereas when the air is injected via the orifice that is arranged downstream from the opening, the deflected flow is oriented in an oblique direction toward the rear of the nacelle.

Preferably, the means for deflecting at least a portion of the flow that can assist the thrust are also used to orient said deflected flow. These means are called a fluid device below.

For this purpose, upstream and/or downstream from the radial opening of the nacelle, the trailing edge comprises a curved surface, preferably convex, into which is injected the thrust reversal fluid. By way of example, whereby the discharge of the thrust reversal fluid is arranged approximately at the ridge formed by the intersection of the lower surface of the conduit of the nacelle and the edge of the opening, the convex curved surface comprises a top part that is offset toward the rear relative to the discharge of the thrust reversal fluid.

Thus, based on aerodynamic and thermodynamic parameters of the thrust reversal fluid, characteristics of the trailing edge upstream and/or downstream from the radial opening (shape, surface condition, . . . ), characteristics of the air flow that flows on the outside of the nacelle, the latter can remain in contact with the curved surface provided at the edge of the trailing edge for a more or less extended period of time.

If the separation point is arranged after the top part and if the aerodynamic and thermodynamic parameters of the thrust reversal fluid are adequate, then the deflected flow is oriented in an oblique direction toward the front of the nacelle (referenced F1 in FIG. 3). In this case, if the resultant of the deflected flow along the thrust axis X is greater than the resultant of the non-deflected flow, a thrust reversal is achieved, whereby the thrust that is generated by the propulsion unit is directed toward the front.

If the separation point is arranged essentially at the top part and if the aerodynamic and thermodynamic parameters of the thrust reversal fluid are adequate, then the deflected flow is oriented in a radial direction (referenced F2 in FIG. 3). In this case, if the flow that assists the thrust is entirely deflected, then an essentially zero thrust is achieved, or in the contrary case, a reduction in thrust is achieved.

If the separation point is arranged before the top part and if the aerodynamic and thermodynamic parameters of the thrust reversal fluid are adequate, then the deflected flow is oriented in an oblique direction toward the rear of the nacelle (referenced F3 in FIG. 3). In this case, a thrust reduction is achieved.

In the different figures, different embodiments are shown.

A fluid device 30 is provided in the wall of the nacelle to monitor the sampling of a quantity or fraction of internal flow in the conduit 26 to evacuate it outside of the nacelle via the radial opening 28. However, the invention is not limited to this embodiment; the fluid device could not make it possible to monitor the quantity or fraction of the flow that was withdrawn.

As shown in FIG. 3 (and in a more detailed way in FIG. 4), the fluid device 30 for monitored sampling is arranged in the wall of the nacelle, more particularly in the stationary part 24a that is located upstream from the opening 28.

The device 30 is arranged on the inside face 24c of the wall 24a of the nacelle, whereby this internal face delimits the annular conduit 26 on its external periphery.

The device 30 makes it possible to inject a high-energy fluid into the internal flow Fi.

This fluid injection is carried out in a way that is essentially tangential to the internal face 24c in a zone of the flow where the latter is to be deflected, i.e., slightly upstream from the trailing edge of the part 24a.

More particularly, the fluid device 30 comprises a channel for bringing in a fluid, which is, for example, pressurized air that comes from the jet engine.

This channel for bringing in fluid comprises a part, not shown, that communicates with the pressurized air source of the gas turbine engine 26 and an annular part 32 that is partially shown in cutaway in FIG. 3. This channel 32 extends at the outside periphery of the annular conduit 26 and is made in the form of one or more ring arcs or else a complete ring arranged on the internal face 24c of the wall of the nacelle.

The fluid device 30 also comprises one or more injection nozzles 34 that communicate with the channel 32 and emerge on the internal face 24c, thus making it possible to inject a high-energy fluid into the flow of internal fluid Fi to the conduit 26 close to the opening 28 (FIG. 4).

A curved surface 35 that constitutes the trailing edge of the upstream wall 24a is located at the exit of the injection nozzle 34, tangentially to the latter. Along a longitudinal cutaway (FIG. 4), this surface is, for example, in the shape of a semi-circle.

It will be noted that when the channel is made in the shape of toric sections (ring arcs) or else a complete ring, the nozzle can assume the shape of a slot and can extend along the entire length of the ring section or the complete ring.

For the same section of ring or for the complete ring, it is also possible to have several separate injection nozzles that are distributed over the section under consideration or on the ring.

As shown in FIGS. 3 and 4, the pressurized fluid that is conveyed by the channel 32 is introduced in the form of a jet into the internal flow of fluid Fi via the injection nozzle 34, tangentially to the internal face 24c, and thus modifies in a controlled way a fraction of this flow.

The thus injected jet comes from the nozzle with a given orientation tangentially to a curved trailing edge that is here the surface 35, then it assumes the shape of the trailing edge, as shown in FIG. 4, to the extent that the centrifugal force that tends to detach it is offset by the negative pressure that arises between the wall and the jet.

The injected fluid jet is therefore deflected by the curved surface 35.

When the equilibrium is upset, the jet that is injected into the flow detaches from the trailing edge and, at the separation point, forms the rear stopping point of the profile.

As shown in FIG. 4, a portion F′i of the internal flow of fluid Fi is deflected from its path under the action of the jet that is injected through the injection nozzle 34 and that is deflected by the surface 35.

The input of energy from the fluid injected via the injection nozzle 34 makes it possible to monitor the position of the separation point.

It will be noted that the direction of the injected fluid jet is controlled by making the position of the separation point of the jet vary on the surface 35.

Thus, based on the zone of the surface 35 where the jet becomes detached, the withdrawn flow part F′i is oriented differently.

This detachment point of the fluid jet, i.e., the orientation of the jet, varies based on at least one of the thermodynamic and aerodynamic parameters of the fluid, namely, for example, the pressure and/or the temperature and/or the flow rate and/or the speed and/or the degree of turbulence . . . .

By way of example, by increasing the flow rate and the pressure of the inductor fluid, the fluid jet adheres to the surface 35 over a great length and the withdrawn flow F′i is deflected upstream from the nacelle in the direction F1 in FIG. 3 (thrust reversal).

When the direction given to the quantity of withdrawn fluid is essentially that indicated by the arrow F2, namely in a radial manner relative to the longitudinal flow Fi, then the direct thrust of the withdrawn flow is cancelled.

In addition, when the quantity of internal flow of withdrawn fluid F′i is oriented in the direction shown by the arrow F3, i.e., downstream from the nacelle, then the direct thrust that is produced by the withdrawn flow is reduced.

It will be noted that it is possible to modify a single thermodynamic and aerodynamic parameter, for example the flow rate, to act on the quantity of withdrawn fluid.

According to the previously described embodiment, it is noted that the means that make it possible to deflect at least a portion of the flow that can assist the thrust also ensure the function of orientation of the deflected flow so as to adjust the thrust reversal and the deceleration. Thus, to modulate the thrust reversal, it is possible to adjust at least one of the criteria corresponding to the ratio between the deflected flow and the non-deflected flow, the orientation of the deflected flow by adjusting at least one of the thermodynamic and aerodynamic parameters of the thrust reversal fluid.

By varying the size of the injection orifice at the exit of the injection nozzle, for example, using a diaphragm-type arrangement, it is possible to vary the rate of injection and therefore the flow rate of injected fluid.

Furthermore, the injection of fluid can be carried out either in continuous flow or in pulsed flow to limit the consumption of injected fluid.

The implementation of an effective system that makes it possible to reverse, to cancel or to reduce the thrust vector of the propulsion system is carried out during certain flight phases of the aircraft by translating the rear part of the wall of the nacelle. Thus, one or more openings 28 are released on the side of the nacelle between the secondary flow Fi that circulates in the annular conduit 26 and the atmosphere.

It should be noted that when the rear part of the wall of the nacelle has been moved toward the rear, the discharge nozzle of the secondary flow no longer brings together the conditions that are suitable for the generation of a thrust vector of a high intensity.

Actually, the nozzle then forms a divergence, and the secondary flow that is a subsonic flow loses its energy by exiting from the nacelle.

The device for reversal, cancellation of or reduction in thrust according to the invention is simpler than the known systems to the extent that, here, it is possible to provide only one moving part, the rear part of the wall of the nacelle, which considerably simplifies the kinematics of the device.

The aerodynamic forces that are linked to the operation of the device according to the invention are concentrated primarily on the fluid device 30 that is arranged in an annular way on the wall of the nacelle, which makes it possible to better distribute in the structure of the nacelle the forces to be transmitted and, thus, to not have to oversize certain parts of the nacelle.

In addition, the fluid device has a tendency to mask the downstream wall 24b compared to the surrounding flow, which makes it possible not to have to oversize the latter.

Furthermore, the integration of the fluid device on the wall of the nacelle has very little influence on the internal and external acoustic treatment of the latter.

Actually, in the folded position shown in the top part of FIG. 3, the device according to the invention allows the integration of a parietal acoustic coating on almost all of the internal and external faces of the wall of the nacelle.

In addition, the size of the fluid device 30 is relatively small, which facilitates its integration into the latter.

FIGS. 5, 6A and 6B illustrate a jet engine nacelle 40 according to a second embodiment of the invention.

A nacelle 40 is attached to the wing of the aircraft by means of a pylon mast 42 that is partially shown. This nacelle comprises a nacelle wall 44 that concentrically surrounds the upstream part of the gas turbine engine 16 that is connected to a fan 22, both being shown in FIG. 3.

In this embodiment, the mechanism for creating (an) opening(s) in the nacelle wall 44 differs from that shown in FIG. 3.

Actually, in this second embodiment, the part of the wall of the nacelle that is able to move longitudinally in the longitudinal direction of the annular conduit 26 constitutes an intermediate part 46 of this wall. In FIG. 5, this intermediate part was withdrawn to make the opening appear for the controlled deflection of flow.

This part 46 extends along an angular sector of the annular wall 44 of the nacelle, and another intermediate part, not shown, can also be arranged symmetrically relative to the pylon mast 42 so as to provide another opening in the nacelle wall.

It will be noted that the intermediate part of retractable wall 46 can also extend along the entire periphery of the nacelle.

The intermediate part of wall 46 comprises two panels 48, 50 (FIG. 6A) that are kept apart radially by two panels that form crosspieces 52 and 54 and that are arranged essentially perpendicular to the panels 48 and 50.

A space 56 of set dimensions is thus provided between the longitudinal panels 48 and 50 that are respectively in contact, in the position of FIG. 6A, with the outside of the nacelle and with the annular conduit 26.

One or more struts, for example two struts 58 and 60, are arranged longitudinally at the inside of the wall of the nacelle.

More particularly, as shown in FIG. 6A, the strut 58 (just like the strut 60) is arranged partially inside a housing 62 that is located in the upstream part 44a of the nacelle.

The housing 62 is arranged at least in such a way as to extend along the corresponding angular sector of the moving part 46.

The stationary part of the strut 58 is fixed by one end 58a to the bottom of the housing 62, while the moving rod 58b of the strut extends inside the intermediate part 46 and is fixed by an opposite end 58c to the crosspiece 54 (FIG. 6A).

In the first position shown in FIG. 6A, the intermediate part of wall 46 is arranged between two stationary parts 44a (upstream part) and 44b (downstream part) of the wall of the nacelle.

In its downstream part, the intermediate part 46 comprises a rounded trailing edge 46a that extends essentially from the end of the wall 46 attached to the crosspiece 54 up to the end of the wall 50 that is also attached to this crosspiece.

In the extended position of the intermediate wall 46, this trailing edge 46a assumes a concave shape corresponding to the leading edge of the part of downstream wall 44b (FIG. 6A).

In retracted position, the trailing edge projects beyond the housing 62 (FIG. 6B).

It will be noted that, when the retraction of the struts is controlled, the rods of the latter retract inside the bodies of the corresponding struts and thus bring back the intermediate part 46 at least partially inside the housing 62, as shown in FIG. 6B.

The thus retracted intermediate wall 46 makes it possible to release an opening 64 in the wall of the nacelle between its trailing edge 46a and the leading edge of the downstream part 44b. Furthermore, it will be noted that upper rollers 66, 68 and lower rollers 70, 72 are attached at the top part and at the bottom part respectively of part 46 (FIG. 5). These rollers slide inside the respective upper and lower rails, not shown, to guide the movement of retraction and deployment of the intermediate part 46 that is acted upon by the struts 58 and 60.

The intermediate part of wall 46 also comprises a fluid device 74 that is analogous to the device 30 of FIGS. 3 and 4 and that has as its function to withdraw a portion of the flow of internal fluid in the conduit 26 by monitoring the quantity of fluid withdrawn and the spatial orientation provided to the latter.

Just like the above-mentioned device 30, the device 74 is located on the internal face of the wall part 46 and comprises a channel for bringing in a high-energy fluid 76 that is produced in the form of a ring arc.

The device 74 also comprises an orifice for injecting this fluid tangentially to the internal flow to the conduit 26. This orifice is made in the form of a slot 78 that extends along the entire length of the channel 76.

The device 74 is also fed, for example, by pressurized air coming from the gas turbine engine 16 by means of a flexible pipe or a telescopic pneumatic junction (not shown), just like the device 30 of FIGS. 3 and 4.

The characteristics and functionalities of the device 74 are identical to those of the device 30 and will therefore not be restated here.

FIGS. 7A to 7C illustrate a variant embodiment of an intermediate wall part of retractable nacelle 80.

The intermediate part 80 is arranged, as shown in FIG. 7A, between two stationary wall parts 82a (upstream part) and 82b (downstream part) of the wall of the nacelle.

The upstream part 82a has an internal housing 84 that is provided to accommodate at least a portion of the intermediate part 80 when the latter is in retracted position as shown in FIG. 7C.

The longitudinally movable part 80 comprises two panels 86, 88 that are kept apart radially (FIG. 7A), but whose separation can vary unlike the embodiment of FIGS. 5, 6A and 6B.

The two panels 86 and 88 are respectively articulated by one of their ends, called a downstream end 86a, 88a on a downstream support 90 that comprises a rounded trailing edge 80a and the fluid device 74 that is identical to that of the embodiment of FIGS. 5, 6A and 6B.

A strut 92 comprises a body 94 and a rod 96 that are arranged on the inside of the nacelle wall.

At one end of the body 94, said body has a head 94a that is housed inside a cavity 98 that is integral with the support 90 and that extends into the internal space delimited by the two panels 86, 88.

The body 94 is secured at its opposite end 94b to the so-called upstream ends 86b, 88b of the panels 86 and 88 by means of two articulated links 100 and 102.

The rod 96 of the strut is attached at its ends 96a that is not integral with the body 94 to the stationary structure of the wall of the nacelle.

Thus, when the retraction control of the intermediate part of the wall 80 activates the retraction of the strut 92, the body 94 of the latter is brought upstream to the inside of the housing 84 following a longitudinal movement shown in FIG. 7B. The head 94a of the body of the strut passes through the cavity 98 to rest against the edges of the opening of said cavity by means of a shoulder, while the articulated links 100 and 102 tilt together with the end 94b of the body.

It follows that the panels 86 and 88 move toward the body 94 and therefore one from the other.

Since the space between them was reduced (FIG. 7B), it wound up underneath one of the panels of the upstream part of wall 82a that delimits the internal housing 84.

Whereby the strut is still actuated, the body 94 of the latter is brought upstream to the inside of the upstream part of wall 82a (FIG. 7C), thus taking with it the articulated wall block 80.

It will be noted that this intermediate wall block is thus doubly retractable since it can be retracted longitudinally, as well as radially, whereby the panels 86 and 88 are actually able to move toward one another during the retraction.

The longitudinal retraction makes it possible to create an opening 104 in the nacelle wall between the stationary elements of the upstream wall 82a and the downstream wall 82b so as to ensure the functionalities that are presented during the description of the preceding embodiments.

In addition, the radial or lateral retraction makes it possible on the part of the intermediate wall to be housed more easily inside the upstream part 82a than the intermediate part of wall 46 shown in FIGS. 5, 6A and 6B.

In the embodiment of FIGS. 5, 6A and 6B, it is actually necessary that the spacing between the panels 48 and 50 be less than the spacing that exists between the walls that define the internal housing 62 of the upstream part 44a.

All that was said above regarding the fluid device for controlled sampling of a portion of the internal flow to the conduit 26 remains valid for the variant shown in FIGS. 7A to 7C.

FIG. 8 illustrates a third embodiment of a nacelle according to the invention in which the mechanism for creating the opening comprises a nacelle wall part that can move longitudinally in translation downstream from the nacelle and not upstream as in the FIGS. 5, 6A, 6B, 7A to 7C.

More particularly, the wall part 110 is moving between two positions, a first position shown at the top of FIG. 8, in which it is arranged between two stationary parts 112a (upstream part) and 112 b (downstream part including the trailing edge of the nacelle) of the wall of the nacelle 112, and a second position shown at the bottom of this same figure. In this second position, the moving part 110 slid toward the rear and an opening 114 was thus created in this wall to allow the deflection of the flow.

It will be noted that, in this embodiment, the intermediate part of wall 110 comprises two panels that are radially offset from one another, one 116 of which is in contact with the outside while the other 118 is in contact with the annular conduit 26.

Under the action of one or more struts, not shown in the figure, the double-wall system 110 slides downstream, for example, by partly covering the stationary part of downstream wall 112b.

The two panels 116 and 118 thus come, for example, to cover the respective internal and external faces of the stationary part of wall 112b.

It will be noted that the strut or struts, not shown, are arranged in the stationary part of wall 112b as were the struts of the embodiments of FIGS. 5, 6A, 6B, 7A to 7C in the stationary part of the upstream wall of the nacelle.

According to a variant embodiment, not shown, the two walls 116 and 118 can also be retracted radially so as to reduce the spacing between the latter by using one or more struts in the manner illustrated in FIGS. 7A to 7C.

The panels 116 and 118 of the intermediate part 110 are then housed at least partially inside the stationary downstream part 112b.

It will be noted that, in the embodiment shown in FIG. 8, the fluid device 30 is not arranged on the moving part of the wall of the nacelle as in the embodiments shown in FIGS. 5, 6A, 6B, 7A to 7B.

Actually, the device 30 is arranged upstream from the opening, and the moving wall part 110 is moved downstream here.

FIG. 9 shows a variant embodiment in which the moving intermediate wall part is also moved toward the rear of the wall of the nacelle 122.

The intermediate part of wall 120 comprises here a single panel that, in the first position shown in the top part of the FIG. 9, is arranged between the two stationary parts—upstream 122a and downstream 122b—of the wall of the nacelle. In the second position shown in the bottom part of this figure, the moving part 120 moves in translation downstream and covers at least partially the external face of the stationary part 122b.

Furthermore, it will be noted that the downstream stationary part 122b is offset radially toward the inside of the nacelle relative to the radial position of the panel of the moving part 120 so that the latter can translate longitudinally without coming up against the stationary part 122b.

There again, the moving intermediate part of the wall of the nacelle makes it possible to create an opening 124 in the latter so as to deflect in a controlled way a portion of the flow of internal fluid to the annular conduit 26.

The fluid sampling device 30 is also arranged independently from the moving wall part and in a stationary manner relative to the latter, contrary to the arrangement provided in FIGS. 5, 6A, 6B, 7A to 7C. It should be noted that the moving intermediate walls 110 and 120 can be extended in an annular manner over the entire periphery of the nacelle or only over one or more annular segments of the latter.

Furthermore, it will be noted that in all of the cases, whereby the rear part of the wall of the nacelle does not move in translation, it is preferable to withdraw, in the annular conduit, at least 20 to 30% of the internal flow to achieve a significant effect on the reversal, the cancellation of or the reduction in thrust via the controlled withdrawal.

In FIGS. 10 to 14, variants were shown that comprise devices that are complementary to the above-described fluid-type thrust reversal device, aiming at improving its effectiveness.

According to an embodiment illustrated in FIGS. 10 to 12, one or more flaps 130 are supported upstream from a trailing edge 132 at the level of which is arranged a fluid device 134 that makes it possible to deflect, in a pneumatic manner, at least a portion of the flow that is able to assist the thrust so as to obtain a deceleration of the aircraft.

According to this embodiment, the nacelle comprises at least one opening 136 that can be blocked by a flap 130 with a shape that is matched to the opening 136, whereby said flap is articulated relative to the nacelle along a pivoting axis 138 that is arranged upstream from the opening in a plane that is essentially perpendicular to the longitudinal axis 140 of the nacelle that corresponds to the axis of the thrust. Thus, the flap 130 can occupy a first position in which it blocks the opening 136 and a second position in which it releases the opening 136 that allows the deflection of at least a portion of the secondary flow using the fluid device 134.

Advantageously, the shapes of the flap are such that they ensure the continuity of the outside surface and the inside conduit of the nacelle.

Advantageously, the nacelle can comprise a number of openings 136 that are distributed over its circumference, each one able to be blocked by a flap 130.

The presence upstream from the opening 136 of a flap 130 makes it possible to create a negative pressure and an aerodynamic disturbance downstream from the flap 130 at the opening that promote the intake of at least a portion of the secondary flow and provides the effectiveness of the fluid device 134.

According to another variant that is illustrated in FIG. 13, the nacelle comprises two parts, a stationary upstream part 142 and a downstream part 144 that moves in translation and that makes it possible to create an opening 146, whereby the trailing edge of the upstream part comprises a fluid device 148. This nacelle is essentially identical to the one that is illustrated in FIG. 3.

At least one flap 150 can be provided outside of the nacelle, upstream from the opening 146, articulated relative to an axis 152 upstream from said opening, arranged in a plane that is essentially perpendicular to the longitudinal axis 154 of the nacelle. This flap 150 can occupy a first so-called folded position in which its outside surface 156 ensures the continuity of the aerodynamic outside surface of the nacelle and a second so-called deployed position in which it projects relative to the outside surface of the nacelle so as to improve the effectiveness of the fluid device 148 by creating a negative pressure and a disturbance at the opening 146.

Generally, the nacelle comprises several flaps 150 that are supported upstream from the opening(s) 146.

According to other variants, one of which is illustrated in FIG. 14, one or more flaps 158 can be articulated relative to the downstream edge of an opening 160 and deployed downstream from said opening 160. This or these flaps make it possible to improve the effectiveness of a fluid device 162 that is placed at the upstream edge of the opening 160 using aerodynamic disturbances that they generate at said opening 160.

As illustrated in FIG. 14, the flap(s) 158 can comprise an edge 164 that can project inside the secondary conduit 166 in a more or less significant manner.

1. Process whose purpose is to reduce, cancel or reverse the thrust generated by at least one air flow that exits from a propulsion unit of an aircraft by deflecting at least a portion of the flow that can assist the thrust, characterized in that it consists in injecting at the propulsion unit a fluid called a thrust reversal fluid for deflecting by a driving effect, from the inside of the nacelle toward the outside of the nacelle, at least a portion of the flow that is able to assist the thrust.

2. Process according to claim 1, wherein it consists in injecting a thrust reversal fluid at or slightly upstream from at least a portion of a trailing edge of at least one conduit that channels the flow that can assist the thrust or an opening that is located at the level of said conduit.

3. Process according to claim 1, wherein it consists in adjusting at least one aerodynamic or thermodynamic parameter of thrust reversal fluid to adjust the ratio between the deflected flow and the non-deflected flow.

4. Process according to claim 1, wherein it consists in injecting the thrust reversal fluid upstream from a convex, curved surface with a top part that is offset toward the rear relative to the discharge of the thrust reversal fluid.

5. Process according to claim 4, wherein it consists in adjusting at least one aerodynamic or thermodynamic parameter of the thrust reversal fluid to regulate the orientation of the deflected flow.

6. Process according to claim 1, wherein it consists in deflecting at least a portion of the flow that can assist the thrust via a temporary opening that can be created at the level of a conduit that channels the flow to be deflected and to inject the thrust reversal fluid at or slightly upstream from at least a portion of the trailing edge upstream from said opening.

7. Process according to claim 6, wherein it consists in generating aerodynamic disturbances at the opening.

8. Device for the implementation of a process for reducing, canceling or reversing the thrust generated by at least one air flow exiting from at least one conduit of a propulsion unit of an aircraft, whereby the propulsion unit comprises means for deflecting at least a portion of the flow that can assist the thrust, wherein it comprises means for injecting at the propulsion unit a fluid called thrust reversal fluid to deflect by a driving effect, from the inside of the nacelle toward the outside of the nacelle, at least a portion of the flow that can assist the thrust.

9. Device according to claim 8, wherein the means for injecting the thrust reversal fluid are arranged at or slightly upstream from at least one part of a trailing edge of at least one conduit that channels the flow that is able to assist the thrust or an opening that is located at the level of said conduit.

10. Device according to claim 9, wherein it comprises a convex, curved surface that is provided along the trailing edge and a thrust reversal fluid discharge that is arranged essentially at the intersection of said curved surface and the inside surface of the conduit that channels the flow to be deflected, whereby the curved surface comprises a top part that is offset toward the rear relative to the discharge of the thrust reversal fluid.

11. Device according to claim 8, wherein the discharge of the thrust reversal fluid has a nozzle shape.

12. Device according to claim 8, wherein it comprises means for adjusting at least one aerodynamic or thermodynamic parameter of the thrust reversal fluid.

13. Aircraft nacelle that comprises a device according claim 8.

14. Aircraft nacelle according to claim 13, comprising a conduit in which a gas turbine engine is arranged concentrically, wherein it comprises at least one temporary opening, making it possible to merge the inside and the outside of a conduit that channels the flow to be deflected and a device according to any of claims 8 and 12 that is arranged at least partially at the trailing edge upstream from said opening.

15. Aircraft nacelle according to claim 14, wherein at its upstream edge, the opening comprises a convex, curved surface and a thrust reversal fluid discharge that is arranged essentially at the intersection of said convex, curved surface and the inside surface of the conduit that channels the flow to be deflected, whereby the convex, curved surface comprises a top part that is offset toward the rear relative to the discharge of the thrust reversal fluid.

16. Aircraft nacelle according to claim 13, wherein the discharge of the thrust reversal fluid has a nozzle shape.

17. Aircraft nacelle according to claim 13, wherein it comprises at least one flap that makes it possible to disturb the aerodynamic flow at the opening.

18. Aircraft nacelle according to claim 17, wherein said at least one flap is arranged upstream from the opening.

19. Aircraft nacelle according to claim 17, wherein said at least one flap is arranged downstream from the opening.

20. Aircraft nacelle according to claim 17, wherein said at least one flap is able to occupy a first position in which its outside surface is in the extension of the outside surface of the nacelle, and a second position in which it projects relative to the outside surface of the nacelle.

21. Aircraft nacelle according to claim 13, wherein it comprises at least one opening that can be sealed by at least one flap, whereby said at least one flap is able to occupy a first position in which it seals the opening and a second position in which it releases the opening.

22. Aircraft nacelle according to claim 13, wherein it comprises at least one stationary part and at least one moving part that can move in translation relative to said at least one stationary part so as to create at least one opening after movement in translation.

23. Aircraft nacelle according to claim 22, wherein it comprises an upstream stationary part and at least one downstream moving part that make it possible to create at least one opening between the upstream and downstream parts after movement in translation of said at least one downstream moving part.

24. Aircraft nacelle according to claim 23, wherein it comprises at least one panel that can move in translation relative to the wall of the nacelle so as to release an opening that is made in the wall of the nacelle.

25. Aircraft that comprises at least one nacelle according to claim 13.
